(19) United States
(12) Patent Application Publication
(10) Pub. No.: US 2001/0024217 A1
(43) Pub. Date: Sep. 27, 2001

(54) Ink jet head having a plurality of units and its manufacturing method

(75) Inventors: Torahiko Kanda, Tokyo (JP); Kenichi Ohno, Tokyo (JP); Yasuhiro Otsuka, Tokyo (JP)

Correspondence Address: Patent Group, Hutchins, Wheeler & Dittmar, 101 Federal Street, Boston, MA, 02110, US

(73) Assignee: NEC Corporation

(21) Appl. No.: 09/778,443

(22) Filed: Feb. 7, 2001

(30) Foreign Application Priority Data
Mar. 21, 2000 (JP) 2000-078898

(51) Int. Cl. B41J 2/145; B41J 2/15

(52) U.S. Cl. 347/40; 347/70

(57) ABSTRACT

An ink jet head is constructed by a plurality of combined units.

### BACKGROUND OF THE INVENTION

1. Field of the Invention

The present invention relates to an ink jet head and its manufacturing method.

2. Description of the Related Art

A prior art ink jet head is constructed by a single unit including laminated substrates such as a monocrystalline silicon substrate and a glass substrate (see JP-A-6-218932). This will be explained later in detail.

In the above-mentioned prior art ink jet head, however, when the density of nozzles is increased to improve the printing quality while the printing speed is being increased, even if one nozzle is defective in one unit, such a unit has to be scrapped, so that the manufacturing yield of the units is decreased, thus increasing the manufacturing cost of the ink jet head.

### SUMMARY OF THE INVENTION

It is an object of the present invention to provide an ink jet head and its manufacturing method capable of decreasing the manufacturing cost.

According to the present invention, an ink jet head is constructed by a plurality of combined units.

Also, in a method for manufacturing an ink jet head, a plurality of units are formed in a substrate. Then, the units are separated from each other. Finally, one ink jet head is formed by combining at least two of the units.

### BRIEF DESCRIPTION OF THE DRAWINGS

The present invention will be more clearly understood from the description set forth below, as compared with the prior art, with reference to the accompanying drawings, wherein:

FIG. 1 is a plan view illustrating a semiconductor wafer where prior art ink jet units are formed;

FIG. 2 is a plan view of one of the ink jet units of FIG. 1;

FIG. 3 is a cross-sectional view of the periphery of one nozzle of FIG. 2;

FIG. 4 is a plan view illustrating a semiconductor wafer where ink jet units according to the present invention are formed;

FIG. 5 is a plan view of one of the ink jet units of FIG. 4;

FIG. 6 is a partially-enlarged view of the unit of FIG. 5;

FIGS. 7A, 7B, 7C and 7D are cross-sectional views taken along the line VII-VII of FIG. 6;

FIGS. 8A and 8B are plan views of the semiconductor wafer of FIG. 4 before and after the separation of units, respectively;

FIG. 9 is a plan view for explaining the combination of two non-defective units of FIGS. 8A and 8B; and

FIG. 10 is a cross-sectional view of the abutting portion of the non-defective units of FIG. 9.

### DESCRIPTION OF THE PREFERRED EMBODIMENT

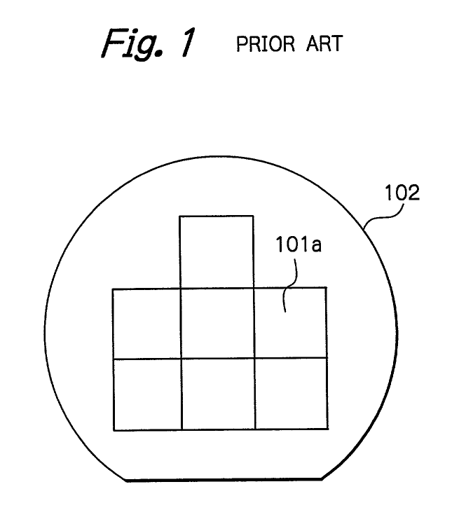

Before the description of the preferred embodiment, a prior art ink jet head will be explained with reference to FIGS. 1, 2 and 3.

A prior art ink jet head is formed by a single unit 101a as illustrated in FIG. 1 including laminated substrates such as a monocrystalling silicon substrate and a glass substrate (see JP-A-6-218932). For example, if each unit 101a has a size of about 27 mm×27 mm, seven units 101a are cut by a dicing blade (not shown) from an about 10-cm diameter monocrystalline silicon wafer 102 as illustrated in FIG. 1.

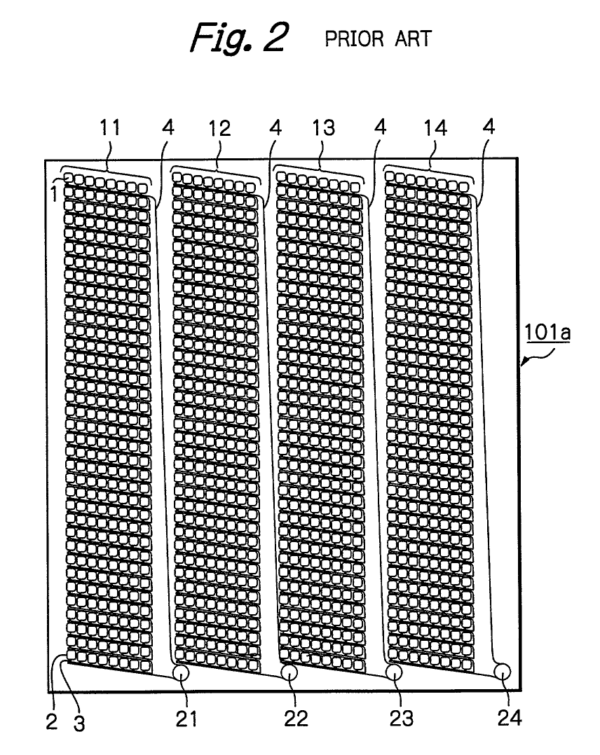

In FIG. 2, which is a detailed plan view of each of the units 101a of FIG. 1, four nozzle columns 11, 12, 13 and 14 where nozzles 1 are closely arranged in a matrix are provided. In this case, the nozzle columns 11, 12, 13 and 14 are used for ejecting black ink, yellow ink, cyan ink and magenta ink, respectively. The nozzle columns 11, 12, 13 and 14 are connected to ink supply holes 21, 22, 23 and 24, respectively.

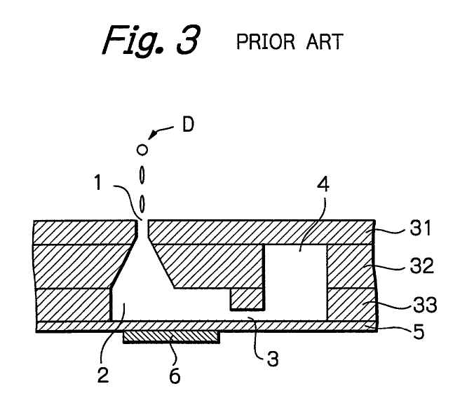

As illustrated in FIG. 3, which is a cross-sectional view of the periphery of one nozzle 1 of FIG. 2, one pressure chamber 2 linked to the nozzle 1, an ink passage 3 and an ink pool (reservoir) 4 are partitioned by a plurality of substrates 31, 32 and 33 made of monocrystalline silicon and glass, and a thin vibration plate 5 on which an actuator 6 made of piezoelectric material sandwiched by metal electrodes is formed. Note that the ink pool 4 for each of the nozzle columns 11, 12, 13 and 14 is comb-shaped as illustrated in FIG. 2.

Also, in FIG. 3, reference D designates an ink droplet.

In the ink jet head formed by a single unit 101a, however, when the density of nozzles is increased to improve the printing quality while the printing speed is being increased, even if one nozzle is clogged or deformed, i.e., defective in one unit 101a, such a unit has to be scrapped, so that the manufacturing yield of the units 101a is decreased, thus increasing the manufacturing cost of the ink jet head.

For example, if the nozzle 1 has a diameter of about 25 to 40 μm, the average number of defective nozzles 1 is expected to be 4 in one monocrystalline silicon wafer 102. In this case, four units 101a may be defective, so that the manufacturing yield of the units 101a in one monocrystalline silicon wafer 102 may be 3/7 (=43 percent).

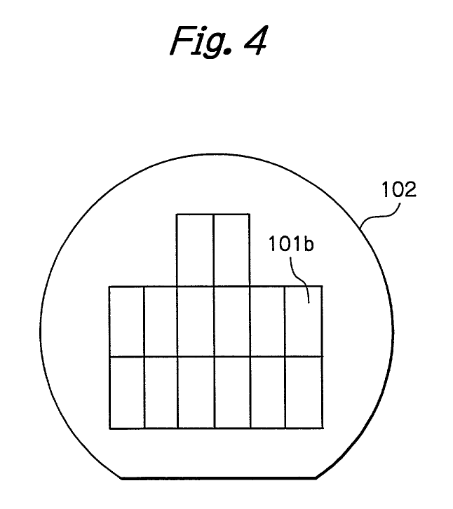

An embodiment of the ink jet head according to the present invention is formed by a plurality of units 101b, for example, two units 101b as illustrated in FIG. 4 including a monocrystalline silicon substrate. For example, if each unit 101b has a size of about 27mm x 13mm, fourteen units 101b are cut by a dicing blade from an about 10-cm diameter monocrystalline silicon wafer 102.

In FIG. 5, which is a detailed plan view of each of the units 101b of FIG. 4, two nozzle columns 11 and 12 where nozzles 1 are closely arranged in a matrix are provided. In this case, the nozzle columns 11 and 12 are used for ejecting black ink (or cyan ink) and yellow ink (or magenta ink), respectively. The nozzle columns 11 and 12 are connected to ink supply holes 21 and 22, respectively.

As illustrated in FIG. 5, in each of the units 102b, a protruded abutting portion 51, a recessed abutting portion 52, a protruded abutting portion 53 and a protruded abutting portion 54 are formed. As a result, a relief (recess) 55 is formed between the protruded abutting portions 51 and 53, and a relief (recess) 56 is formed between the abutting portions 52 and 54. Note that the protruded abutting portion 51 has the same shape as the recessed abutting portion 52.

In the ink jet head formed by two of the units 101b, if the nozzle 9 has a diameter of about 25 to 40 μm, the average number of defective nozzles 1 is also expected to be 4 among one monocrystalline silicon wafer 102. In this case, four units 101b may be defective, so that the manufacturing yield of the units 101b among one monocrystalline silicon wafer 102 may be 3/14 (=22 percent). Thus, the manufacturing yield can be remarkably increased as compared with the prior art units 101a.

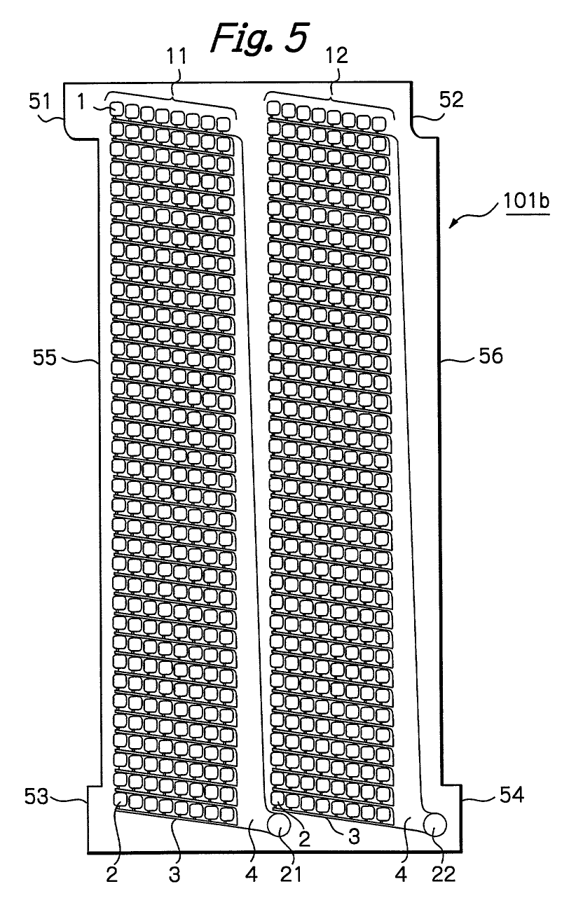

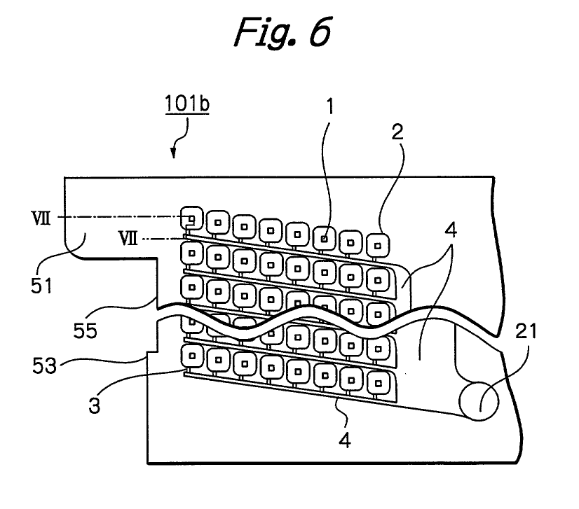

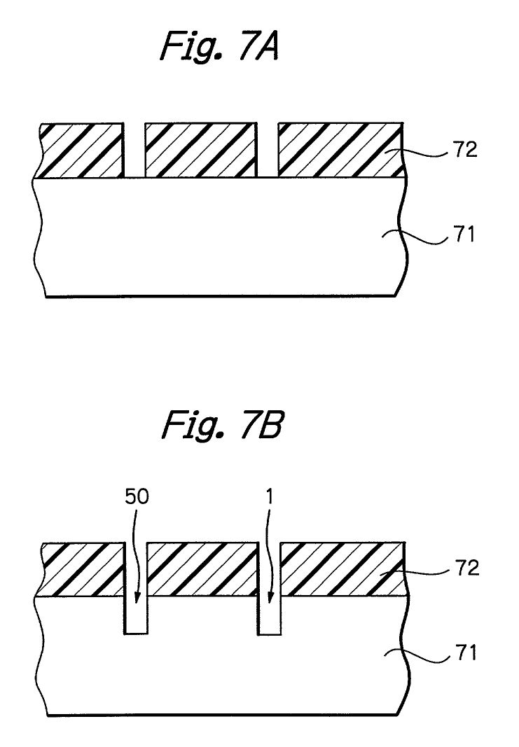

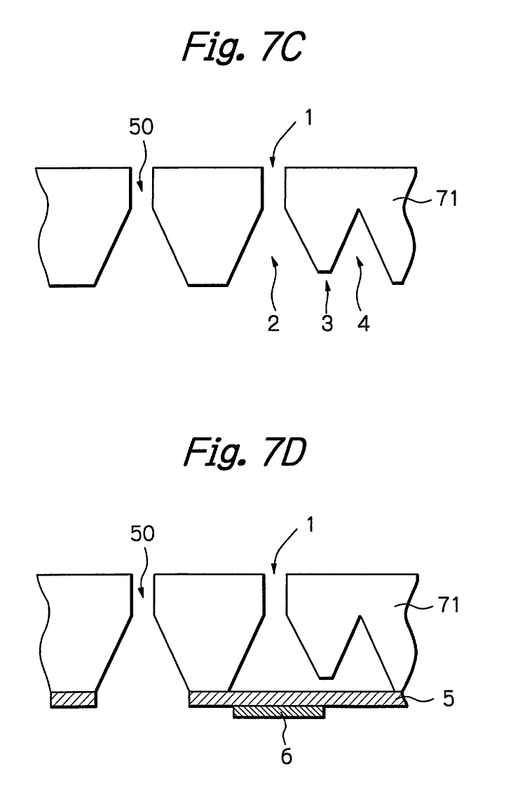

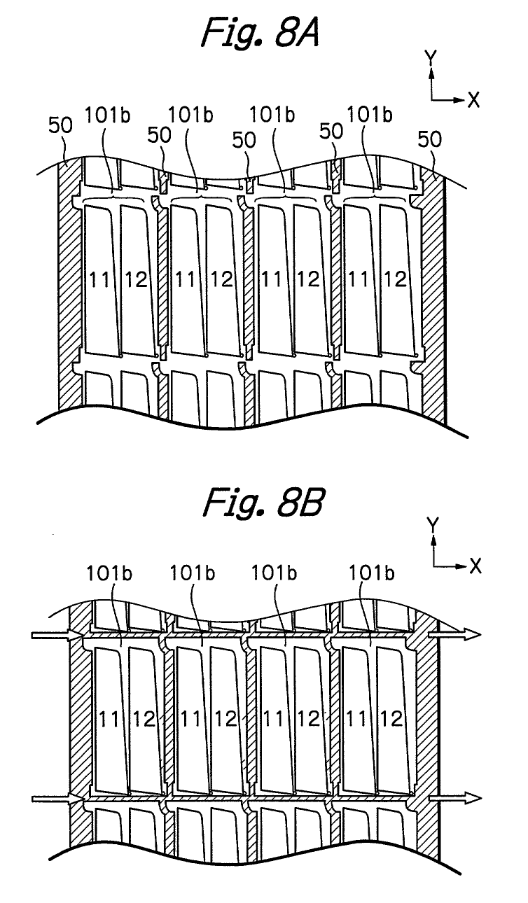

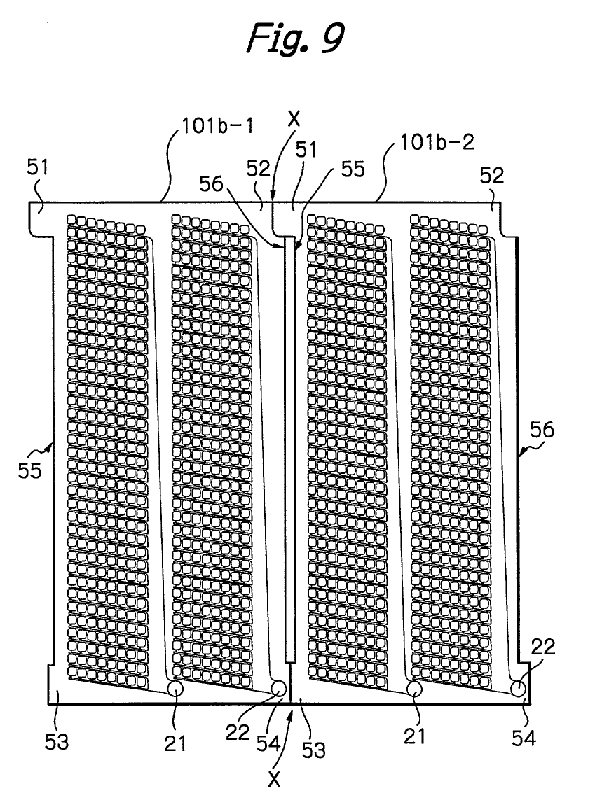

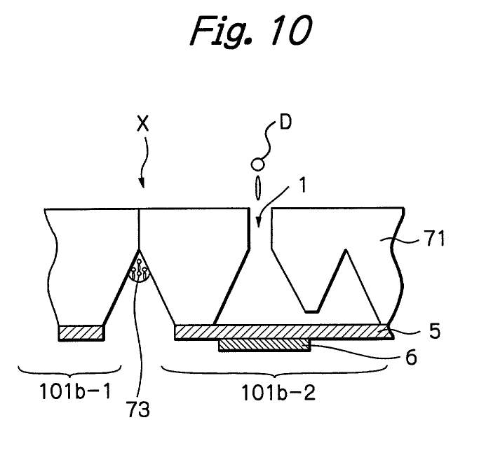

A method for manufacturing an ink jet head according to the present invention is explained next with reference to FIGS. 6, 7A, 7B, 7C, 7D, 8A, 8B, 9 and 10. Note that FIG. 6 is a partially-enlarged view of the unit 101b of FIG. 5, and FIGS. 7A, 7B, 7C and 7D are cross-sectional views taken along the line VII-VII of FIG. 6. Also, FIGS. 8A and 8B are plan views of the semiconductor wafer of FIG. 4 before and after the separation of units respectively. Further, FIG. 9 is a plan view for explaining the combination of two non-defective units of FIGS. 8A and 8B, and FIG. 10 is a cross-sectional view of the abutting portion of the non-defective units of FIG. 9.

First, referring to FIG. 7A as well as FIG. 6, a photoresist pattern 72 is formed by a photolithography process on a front surface of a monocrystalline silicon substrate 71.

Next, referring to FIG. 7B as well as FIG. 6, the monocrystalline silicon substrate 71 is etched by a reactive ion etching (RIE) dry process using the photoresist pattern 72 as a mask. As a result, a nozzle 1 is perforated in the monocrystalline silicon substrate 71, and simultaneously, an edge 50 for the abutting portions 51, 52, 53 and 54 and the reliefs 55 and 56 is perforated. Then, the photoresist pattern layer 72 is removed.

Next, referring to FIG. 7C as well as FIG. 6, a photoresist pattern layer (not shown) is formed by a photolithography process on a back surface of the monocrystalline silicon substrate 71. Then, the monocrystalline silicon substrate 71 is etched by an anisotropy wet etching process using the photoresist pattern layer as a mask. As a result, a pressure chamber 2, an ink passage 3 and an ink pool (reservoir) 4 are perforated in the monocrystalline silicon substrate 71, and simultaneously, the edge 50 for the abutting portions 51, 52, 53 and 54 and the reliefs 55 and 56 is completely perforated through the monocrystalline silicon substrate 71. Then, the photoresist pattern layer is removed.

In this state, it is determined whether a clogging state (deformed state) is observed in the nozzle 1, the pressure chamber 3, the ink passage 3 and the ink pool (reservoir) 4.

Next, referring to FIG. 7D as well as FIG. 6, a wafer-type thin vibration plate 5, which is perforated in advance to be adapted to the edge 50, is adhered by a contact bonding process to the back surface of the monocrystalline silicon substrate 71. Then, one actuator 6 made of piezoelectric material sandwiched by metal electrodes is adhered by a contact bonding process to the thin vibration plate 5 in correspondence with each nozzle 1.

In FIG. 7D, note that it is possible to adhere actuators 6 to a wafer-type thin vibration plate 5 before the wafer-type thin vibration plate 5 is adhered to the back surface of the monocrystalline silicon substrate 71.

Next, the separation of the units 101b is explained with reference to FIGS. 8A and 8B.

After the process as illustrated in FIG. 7D, the monocrystalline silicon substrate 71 is divided by the edge 50 along the Y-direction into columns of the units 101b, as illustrated in FIG. 8A.

Next, as illustrated in FIG. 8B, the monocrystalline silicon substrate 71 is cut by a dicing blade (not shown) along the X-direction. As a result, each of the units 101b is completely separated from each other.

In this state, it is again determined whether a clogging state (deformed state) is observed in each of the units 101b. Then, defective units 101b having a clogging state (deformed state) are scrapped.

Next, referring to FIG. 9, an ink jet head is constructed by combining two non-defective units 101b-1 and 101b-2. That is, the recessed abutting portion 52 of the non-defective unit 101b-i abuts against the protruded abutting portion 51 of the non-defective unit 101b-2, while the protruded abutting portion 54 of the non-defective unit 101b-1 abuts against the protruded abutting portion 53 of the non-defective unit 101b-2. In this case, the contact characteristics between the non-defective units 101b-i and 101b-2 can be improved due to the presence of the reliefs 55 and 56 thereof. Then, the abutting portions of the non-defective units 101b-1 and 101b-2 indicated by arrows X in FIG. 9 are filled with adhesives 73, as illustrated in FIG. 10.

Finally, electrical connections are formed on the back surface of the combined units 101b-i and 101b-2, and the ink supply holes 21 and 22 thereof are coupled to individual ink tanks for black ink, yellow ink, cyan ink and magenta ink, respectively.

The combination of the units 101b-1 and 101b-2 can be carried out without an expensive alignment apparatus, which would decrease the manufacturing cost.

Also, since the abutting portions 51, 52, 53 and 54 are formed by a photolithography and etching process, not a dicing blade, the accuracy of the distance between the edge 50 of the abutting portions 51, 52, 53 and 54 and the nozzles 1 of each of the combined units 101b-i and 101b-2 can be high, i.e., about ±1 μm. As a result, the accuracy of the alignment of the nozzles 1 between the combined units 101b-i and 101b-2 can be high, i.e., about ±5 μm. Note that, if the abutting portions 51, 52, 53 and 54 are formed by a dicing blade, the above-mentioned distance accuracy may be ±6 μm, and the above-mentioned alignment accuracy may be ±10 μm.

Thus, the deviation of droplets among black ink, yellow ink, cyan ink and magenta ink can be decrease, which could not degrade the printing quality.

In the above-described embodiment, one ink jet head is constructed by two combined units 101b-i and 101b-2; however, one ink jet head can be constructed by three or more combined units. For example, if one unit is formed for one nozzle column, one ink jet head can be constructed by four combined units.

Also, in the above-described embodiment, the substrate 71 is made of monocrystalline silicon; however, the substrate 71 can be made of other crystal or metal. If the substrate 71 is made of metal, a mechanical pressing process or an electroforming process can be performed thereon, so that the nozzles 1 and the like can be formed.

Further, in the above-described embodiment, the nozzles 1 are arranged in a matrix in each of the nozzle columns 11 and 12; however, the arrangement of the nozzles 1 can be staggered in each of the nozzle columns 11 and 12.

As explained hereinabove, according to the present invention, since one ink jet head is constructed by a plurality of combined units, the manufacturing yield of each unit is increased, so that the manufacturing yield of the ink jet head can be increased, which would decrease the manufacturing cost.

1. An ink jet head comprising a plurality of combined units.

2. The ink jet head as set forth in claim 1, wherein each of said units comprises:
a first protruded abutting portion;
a recessed abutting portion positioned at an opposite side of said first protruded abutting portion and adapted to said first protruded abutting portion;
a second protruded abutting portion on the same side of said first protruded abutting portion; and
a third protruded abutting portion positioned on an opposite side of said second protruded abutting portion and adapted to said second protruded abutting portion.

3. The ink jet head as set forth in claim 2, wherein the recessed abutting portion and the third protruded abutting portion of one of said units abuts against the first and second protruded abutting portions, respectively, of another of said units.

4. The ink jet head as set forth in claim 1, wherein said units comprises:
a silicon substrate where nozzles, pressure chambers, ink passage and ink pools are formed;
a vibration plate fixed to said silicon substrate to partition said pressure chambers and said ink passages and said ink pools; and
actuators, fixed to said vibration plate, each for vibrating a portion of said vibration plate corresponding to one of said nozzles.

5. A method for manufacturing an ink jet head, comprising the steps of:
forming a plurality of units in a substrate;
separating said units from each other; and
forming one ink jet head by combining at least two of said units.

6. The method as set forth in claim 5, wherein said unit forming step comprises the steps of:
forming edge portions along a first direction and nozzles in said substrate, said edges dividing said units;
forming pressure chambers, ink passages and ink pools in said substrate;
adhering a vibration plate to said substrate to partition said pressure chambers, said ink passages and said ink pools; and
adhering actuators to said vibration plate.

7. The method as set forth in claim 6, wherein said edge and nozzle forming step uses a photolithography and dry etching process.

8. The method as set forth in claim 6, wherein said pressure chamber, ink passage and ink pool forming step uses a photolithography and anisotropic etching process.

9. The method as set forth in claim 6, wherein said separating step comprises a step of cutting said substrate by a dicing blade along a second direction perpendicular to said first direction.

10. The method as set forth in claim 5, wherein said unit forming step comprises the steps of:
forming edge portions along a first direction and nozzles in said substrate, said edges dividing said units;
forming pressure chambers, ink passages and ink pools in said substrate;
preparing a vibration plate to which actuators are adhered in advance; and
adhering said vibration plate to said substrate to partition said pressure chambers, said ink passages and said ink pools.

11. The method as set forth in claim 10, wherein said edge and nozzle forming step uses a photolithography and dry etching process.

12. The method as set forth in claim 10, wherein said pressure chamber, ink passage and ink pool forming step uses a photolithography and anisotropic etching process.

13. The method as set forth in claim 10, wherein said separating step comprises a step of cutting said substrate by a dicing blade along a second direction perpendicular to said first direction.

14. The method as set forth in claim 5, wherein each of said units comprises:
a first protruded abutting portion;
a recessed abutting portion positioned at an opposite side of said first protruded abutting portion and adapted to said first protruded abutting portion;
a second protruded abutting portion on the same side of said first protruded abutting portion; and
a third protruded abutting portion positioned on an opposite side of said second protruded abutting portion and adapted to said second protruded abutting portion.

15. The method as set forth in claim 14, wherein said ink jet head forming step abuts the recessed abutting portion and the third protruded abutting portion of one of said units against the first and second protruded abutting portions, respectively, of another of said units.
